(19) United States
(12) Patent Application Publication
(10) Pub. No.: US 2003/0065526 A1
(43) Pub. Date: Apr. 3, 2003

(54) Historical beauty record

(76) Inventors: Daniela Giacchetti, Paris (FR); Francis Pruche, Senlis (FR); Gilles Rubinstenn, Paris (FR)

Correspondence Address: FINNEGAN, HENDERSON, FARABOW, GARRETT & DUNNER, L.L.P., 1300 I Street, N.W., Washington, DC, 20005-3315, US

(21) Appl. No.: 10/024,622

(22) Filed: Dec. 21, 2001

Related U.S. Application Data
(60) Provisional application No. 60/325,559, filed on Oct. 1, 2001.

(51) Int. Cl. G06F 17/60

(52) U.S. Cl. 705/1

(57) ABSTRACT

Systems, methods, and apparatus consistent with the present invention may be used to provide subjects with information reflecting cosmetic product usage. At least one cosmetic product may be distributed to a beauty facility. Images of an external body condition of subject may be captured before and after the use of cosmetic products. Information reflecting the use of cosmetic products may then be presented to the subject, thereby allowing the subject to track beauty care progress.

### BACKGROUND OF THE INVENTION

1. Field of the Invention

The present invention generally relates to interactive computer systems, and more particularly to methods, combinations, apparatus, systems, and articles of manufacture for providing information reflecting the use of beauty products.

2. Description of Related Art

Although the invention, in its broadest sense, is not inherently related or limited to beauty products, the beauty product market will be used herein to convey some of the aspects associated with the present invention.

Beauty products, such as anti-wrinkle creams, often require sustained use over a period of time before appreciable results are observable. As a result, the effectiveness of a chosen product may be difficult for the consumer to evaluate. This predicament may be especially acute with regard to products that provide incremental results over an extended period of time. For instance, after a few weeks of use, typical consumers may not notice results, despite that the product may be working very well. Because consumers are unable to track their progress, they may be unable to make informed determinations as to the actual effectiveness of products. For example, without a reference with which to compare, a consumer may not fully appreciate the actual improvements to the condition. Consequently, consumers may become frustrated and discontinue beauty product use.

Moreover, certain skin conditions may be aggravated by lifestyle or environmental conditions. For example, freckle intensity may increase with sun exposure. And cold winter climates, for example, may have a detrimental effect on skin textures. Often, consumers do not fully appreciate, and lack appropriate mechanisms for considering, causal relationships between their lifestyle and skin conditions.

### SUMMARY OF A FEW ASPECTS OF THE INVENTION

Systems, methods, and apparatus, consistent with principles of the present invention, address the above and other problems by providing methods for prescribing beauty products and allowing consumers to view the effects of using the beauty products.

One aspect of the invention may involve a beauty care method. The method may include obtaining first information representative of an external body condition of a subject, obtaining second information representative of the external body condition of the subject after the subject uses a beauty product, facilitating storage of information reflecting the subject's usage of the beauty product, and enabling the subject to view the first information, the second information, and at least part of the stored information. The first information and the second information may include an image of the external body condition.

Another beauty care method consistent with the invention may include providing products and/or information about products directly to consumers or supplying products and/or information about products for sale to beauty facilities. The present invention may also facilitate electronic capture of an image of an external body condition of a subject, such as an image of a skin condition (e.g., wrinkles) on a subject's face. Accordingly, there may be provided methods for encouraging a subject to use beauty products or services to treat the condition (e.g. anti-wrinkle agent). The present invention may also facilitate the electronic capture of at least one other image of the subject's external condition after the subject uses the beauty product(s).

Methods consistent with the present invention may further allow the subject to visually observe changes that have occurred as a result of using the beauty products. In one embodiment, methods may be provided for presenting to the subject images captured before and after product usage. Further, information reflecting the effects of products may also be presented.

Yet another aspect of the present invention may involve maintaining beauty information and/or personal information about a subject. The invention may allow the stored personal beauty information to be accessed and updated. The access may be maintained and controlled by the subject. Consistent with exemplary embodiments of the present invention, methods may involve providing beauty recommendations to the individual based on all or a portion of the maintained information. This may include comparing the subject's beauty information and personal information with information about a plurality of individuals. Methods may be provided for determining whether the subject's beauty information is consistent with that of at least some of the plurality of individuals with similar lifestyles. For example, this may include determining if the subject is using the same beauty products as other subjects living in the same climate.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing and the following descriptions are exemplary and explanatory only.

### BRIEF DESCRIPTION OF THE DRAWINGS

The accompanying drawings, which are incorporated in and constitute a part of this specification exemplify the present invention and together with the description, serve to explain principles of the invention.

FIG. 1 depicts an exemplary screen shot consistent with the present invention;

FIG. 2A is a first flowchart consistent with methods of the present invention;

FIG. 2B is a second flowchart consistent with methods of the present invention;

FIG. 3 depicts exemplary front views of transportable computer readable media consistent with an embodiment of the present invention;

FIG. 4 is an exemplary screen shot and network schematic consistent with the present invention;

FIG. 5 depicts another exemplary screen shot consistent with the present invention;

FIG. 6 is an exemplary block diagram of a system in which the present invention may be practiced;

FIG. 7 is a detailed block diagram representative of an exemplary access system located in the beauty facility or remote location depicted in the system of FIG. 6;

FIG. 8 is a detailed block diagram representative of an exemplary server system located in the distributor of FIG. 6; and

FIG. 9 is detailed a flowchart consistent with one exemplary embodiment of the present invention.

### DESCRIPTION OF EXEMPLARY EMBODIMENTS

In the following description of exemplary embodiments, reference will be made to the accompanying drawings in which like numerals represent the same or like elements.

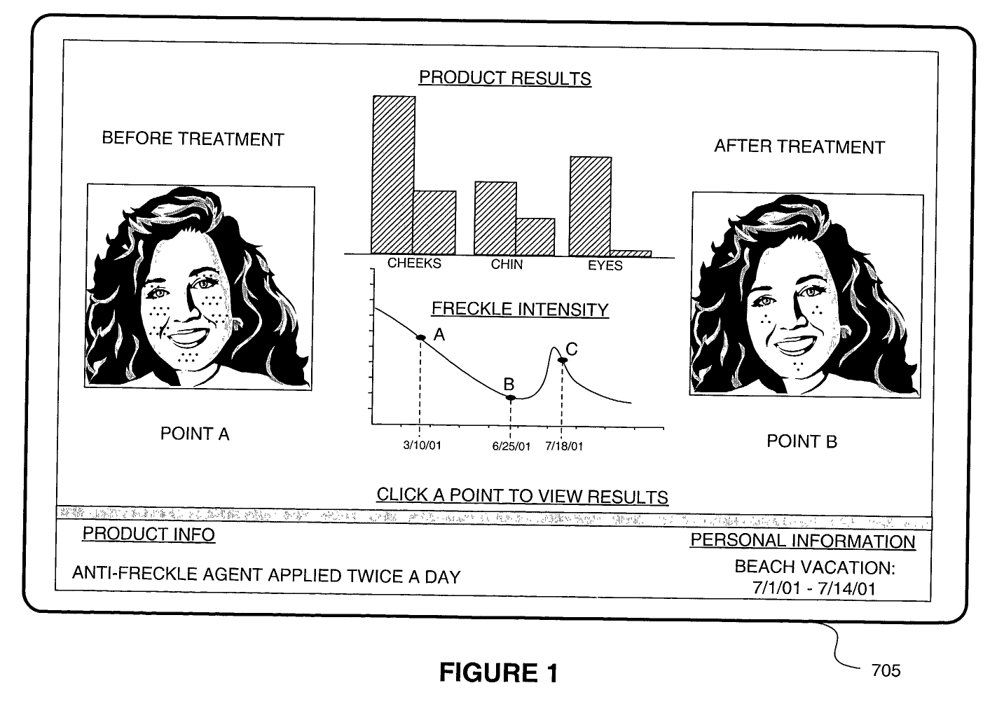

Consistent with exemplary embodiments of the present invention, methods may be provided for allowing subjects to track their beauty care progress. One exemplary embodiment of the present invention is illustrated, by way of example, in the screen shot of FIG. 1. As illustrated in FIG. 1, the present invention may involve simultaneously displaying images captured before and after the use of a beauty product (e.g., anti-freckle agent). Methods of the present invention may also involve graphically displaying information reflecting the use of the beauty product. For example, FIG. 1 includes a graph depicting freckle intensity versus time.

The foregoing discussion is intended to introduce and clarify some of the aspects associated with the present invention by way of the exemplary embodiment depicted in FIG. 1. Further details of this embodiment, as well as additional aspects and embodiments of the present invention will be described in the following discussion. However, it is to be understood that other alternative embodiments may be utilized and that structural changes may be made without departing from the scope of present invention. The foregoing and following description are, therefore, not to be construed in a limiting sense.

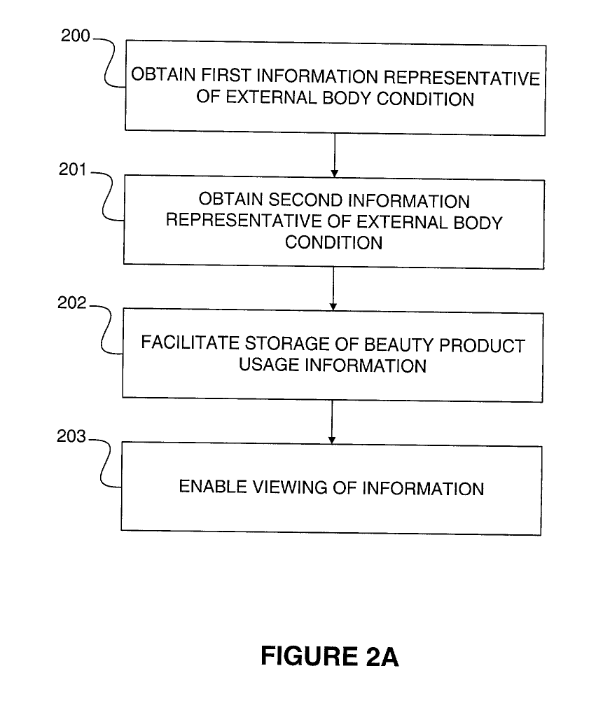

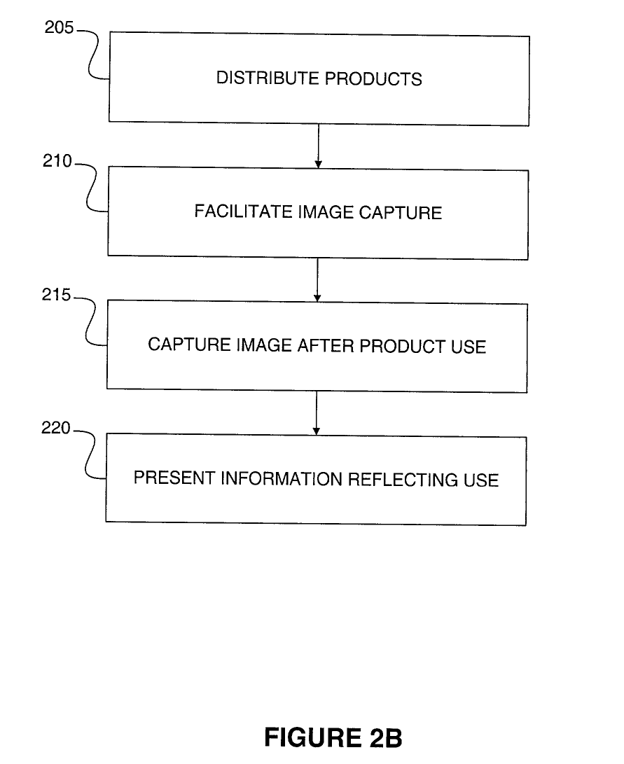

A method consistent with the present invention may include a beauty care method, as illustrated in a flowchart of FIG. 2A. Consistent with the invention, the method may include obtaining first information representative of an external body condition, as indicated at step 200 of FIG. 2A. The first information may include one or more of images, representations, information extracted from images or representations, measurements, observations, qualifications and/or any other data reflective of the subject's external body condition. As used herein, the term “external body condition” refers to any physical, physiological, biological, and/or aesthetic condition of a subject's body including, but not limited to, a skin condition.

The first information may be obtained through direct or indirect actions. For example, the first information might be directly maintained through electronic or physical channels. These channels may include at least one of a network, storage medium, verbal communication, written communication, electronic communication, or any other manner capable of conveying the information. Alternatively, obtaining may be accomplished by providing software or instructions to a third party or to the subject on how to capture, record, and/or store the first information.

Consistent with the invention, a method may also include obtaining second information representative of the external body condition after the subject has used a beauty product, as illustrated at step 201 of FIG. 2A. Thus, the second information may be collected after the first information is collected. The second information may be of a same or similar type to the information described in connection with block 200. Similarly, the manner in which the second information may be obtained may be similar to one described in connection with the first information.

Beauty products may include, but are not limited to, moisturizers, anti-aging products, anti-wrinkle products, anti-freckle products, skin conditioners, skin toners, skin coloring agents, hair coloring, hair cleansing, hair styling, elasticity enhancing products, cosmetic products, and any other product for enhancing the outward appearance of the subject. Beauty products may also include services such as hair styling, hair cutting, hair coloring, hair removal, skin treatment, make-up application, and any other offering or action for altering an aesthetic appearance.

A method consistent with the invention may further include facilitating storage of information reflecting a subject's usage of a beauty product, as shown at step 202 of FIG. 2A. Facilitating storage may include acts of directly storing of the usage information or may include the indirect acts of providing direction or tools to another party, such as the subject, for saving and/or maintaining the information. Such tools may include, for example, software provided to the subject or maintained on a network for the subject's access.

The tools may enable the subject to store information on recordable media. “Recordable media” may refer to any tangible media upon which information may be recorded including, but not limited to, magnetic storage medium, organic storage medium, optical disc medium, and flash memory devices.

Information reflecting the subject's usage of the beauty product may include frequency of usage, intensity of usage, and any other information that might identify products and how they were used.

Consistent with the invention, a method may additionally include enabling a subject to view first information, second information, and at least part of stored usage information, as indicated at step 203 of FIG. 2A. “Enabling” may include providing the subject with tools for viewing the various items of information. The tools may include, for example, one or more of software, access to a display device, or access to a network location where the information is viewable.

Another beauty care method consistent with the present invention may include distributing beauty products, as indicated in step 205 of FIG. 2B. Beauty products may be distributed in one or more of several ways. As used herein, any form of the word “distribute” includes one or more of manufacturing, advertising, reselling, wholesaling, selling, offering for sale, or providing information on the beauty products. Thus, one who advertises a product via an electronic channel of commerce, or who provides a hyperlink to a site that advertises or offers for sale a product, is included within the definition of one who distributes the product, and is also included within the definition of one who offers the product for sale.

As used herein, a “beauty facility” includes one or more of a retail establishment (e.g. department store), beauty salon, hair salon, spa, or any other establishment providing beauty products and/or services. Thus, in one embodiment, the distributor may be an intermediary who supplies a beauty facility with products for retail sale. In another embodiment, the distributor of beauty products may offer products for sale directly to consumers. For example, a cosmetic company may offer products for sale, directly, via catalogs, the Internet or company store. In alternative embodiments, the products may be given to subjects on a trial basis as part of a marketing promotion. Moreover, the beauty facility may provide the product through the performance of a service. For example, a beauty salon may perform makeovers or a hair salon may style and color hair.

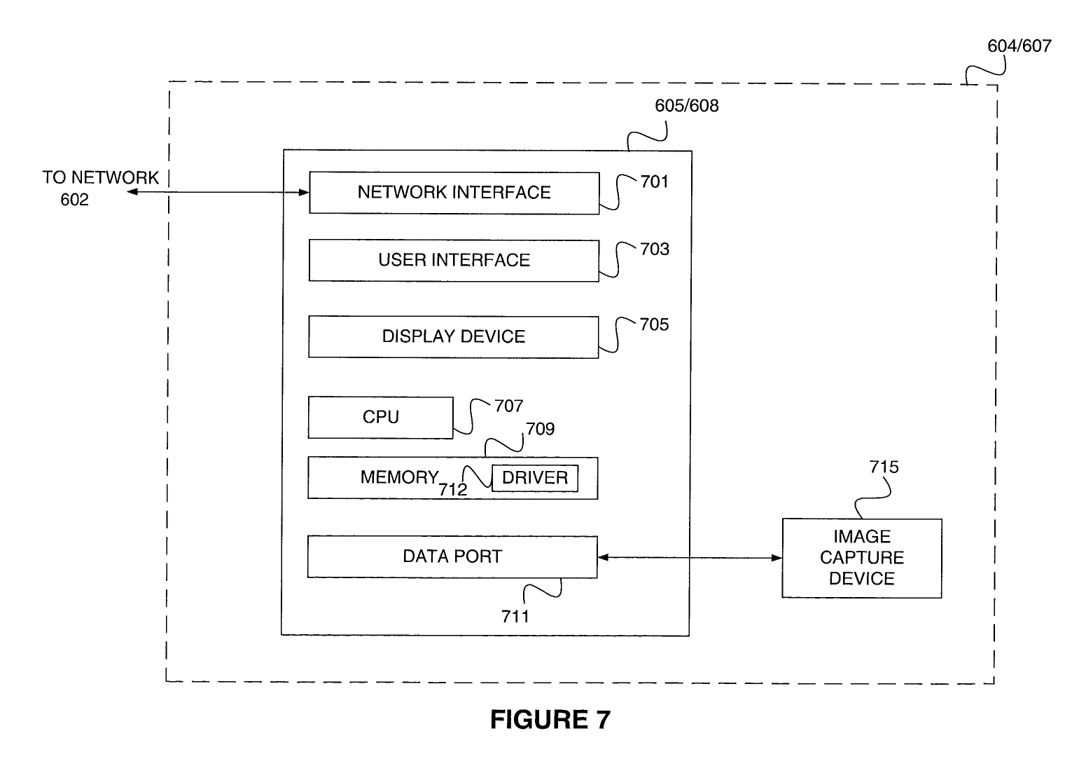

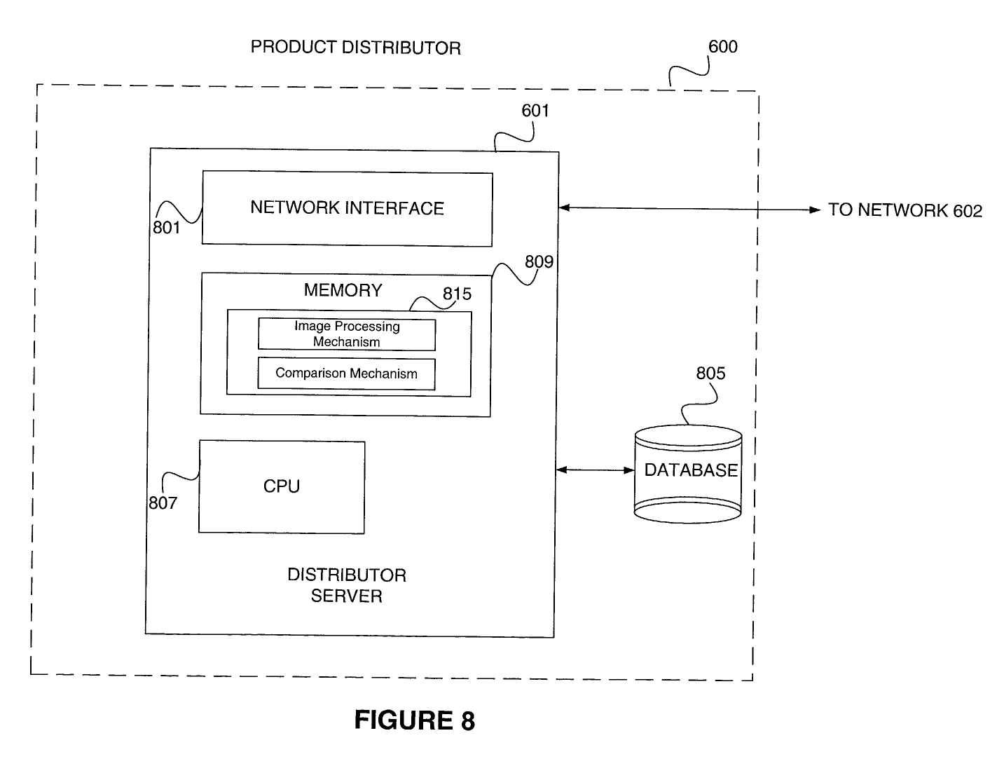

Methods consistent with the present invention, may include facilitating electronic capture of an image of an external body condition of a subject. This a graphically depicted in step 210 of FIG. 2B. In one embodiment, the image may be captured at the beauty facility. Accordingly, facilitating may involve supplying the beauty facility with image capture equipment, which may include hardware and/or software. The hardware may include an image capture device (e.g., a camera, scanner, etc.) and the software may include an associated device driver. Exemplary details are described later in connection with FIGS. 7 and 8.

In other embodiments, facilitating image capture may simply involve encouraging the beauty facility or individual subjects to obtain the necessary equipment for capturing images. In an even broader sense, facilitating might simply include providing instructions or encouragement to capture an image, either through a web site or through any other form of information transfer.

In addition to images, personal information and beauty information may be stored and maintained. Beauty information may include beauty product information such as description, dosage, application frequency, and/or duration of use. Beauty information may also include any other information related to a subject's beauty habits or history. Personal information may include information about physical characteristics, fashion preferences, area of residence, vacation patterns, climate conditions at areas of residence and vacation, or any other information correlating to the subject's personal habits or lifestyle.

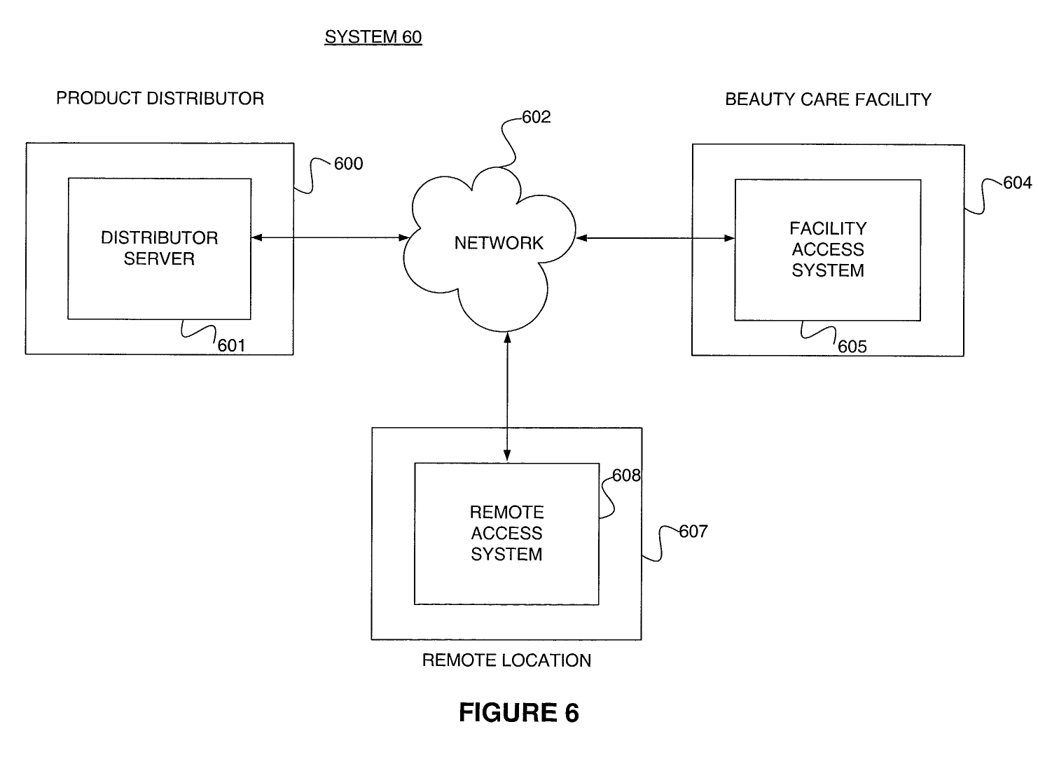

In one embodiment, subjects may be able to enter and update personal and beauty information at the beauty facility via a facility access system. Subjects may also be able to enter and update this information at a remote location such as their homes or offices. Moreover, a subject could begin entering information at one location and continue at another. Exemplary details of these embodiments will be described later in connection with FIGS. 6 and 7.

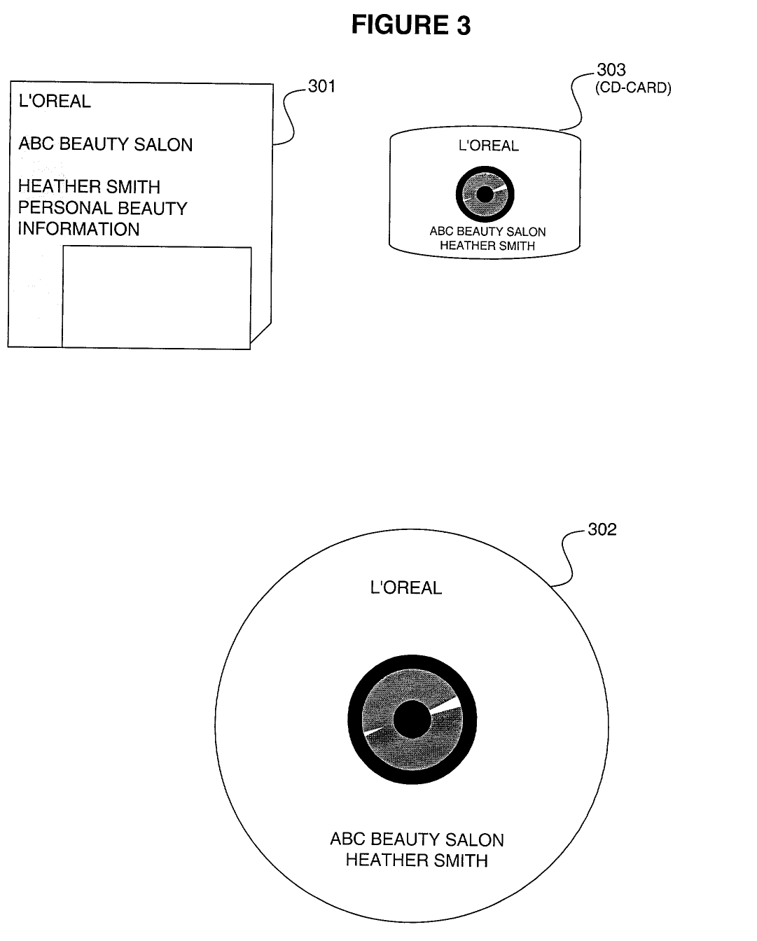

In an exemplary embodiment of the present invention, captured images, personal information, and beauty information may be stored and maintained for later use. This may involve maintaining a database or storing the images and information in a data structure contained in a computer's memory. In other embodiments, images may be stored on transportable recordable media. In one embodiment, recordable media may be supplied (to the subject) by the distributor via the beauty facility. Accordingly, the media may further include visual markings for identifying distributor and/or beauty facility. Examples of transportable recordable media with identifying markings are shown in FIG. 3. Transportable media may be especially appealing to consumers who wish to keep images of themselves private.

Use of transportable media may allow subjects to access and/or update their personal histories at a variety of locations. For example, a subject might receive a disk as part of a visit to a spa. While the disk may contain images captured at the spa, the subject may be able to take the disk home and continue recording beauty history on the same medium. Thus, the disk may also contain software for enabling the continued update. Alternatively, the subject might use remote software accessed over a network to update the historical record.

When the subject visits another participating beauty facility, the historical record may be updated at that location as well. This may not only be beneficial for tracking historical beauty information, but could also be useful for achieving reproducible beauty results. For example, a subject might maintain visual records of beauty applications, hair styles, or hair cuts, and the disk might be used as a guide by a beauty professional to reproduce those results. To that end, detailed information might be contained in the record for guiding the beauty professional.

The subject may be able to update the historical record by capturing a facial image using her own equipment, such as a web cam. Or, the subject might be given an option of simulating an existing condition by modifying a copy of a prior stored image. To this end, the subject may apply to a copy of a pre-existing image an image of a skin condition. The image of this skin condition may be chosen from a pick-list and applied to the image using image processing techniques. In this manner, a subject, without access to an image capture device, may update a visual historical record.

Of course, the transportable media does not necessarily have to be used in connection with a beauty facility. The transportable media may be used solely at home, solely at a beauty facility, or, as discussed, in a combination of locations.

While the invention, in its broadest sense, does not require the use of transportable media, such media may provide the subject with an increased sense of privacy by maintaining confidential information within the direct control of the subject. Obviously, confidentiality may also be achieved in a network environment using protocols that store confidential portions of information at secure locations, such as, for example, the subject's hard drive.

For added security in a network environment, additional security techniques may be employed. Such techniques may include, for example, encryption, secure socket layer (SSL) technology, virtual private network (VPN) technology, password protection, or any other mechanism for securing data storage and transmission.

The historical beauty record may allow for highly customized advice based on long term patterns. That is, the longer the subject maintains the record, the more information exists upon which advice may be rendered. Artificial intelligence search engines may be configured to search the historical data for patterns corresponding to stored population data, and render advice therefrom.

Consistent with principles of the present invention, the subject may be encouraged to use a specific beauty product or service for treating the subject's external condition. This may simply involve offering a variety of products to the subject and allowing the subject to choose at least one. However, encouraging may further involve providing the subject with advice including, but not limited to, product prescriptions, appointments for service, and remedial or preventative measures. In exemplary embodiments, the present invention may include software for providing this advice. The software may involve one or more of an image processing mechanism for analyzing captured images, identifying external conditions, and providing advice based on conditions. In alternative embodiments, the software may provide instructions for identifying an external condition and providing appropriate advice. For example, instructions may be provided to a live beautician for advising a subject or client. In yet another embodiment, the instructions may be provided directly to the subject, thereby allowing the subject to perform a self evaluation. In one implementation, the above-mentioned software may reside in a server at the distributor. Additional details of the software will be addressed later in connection with FIG. 8.

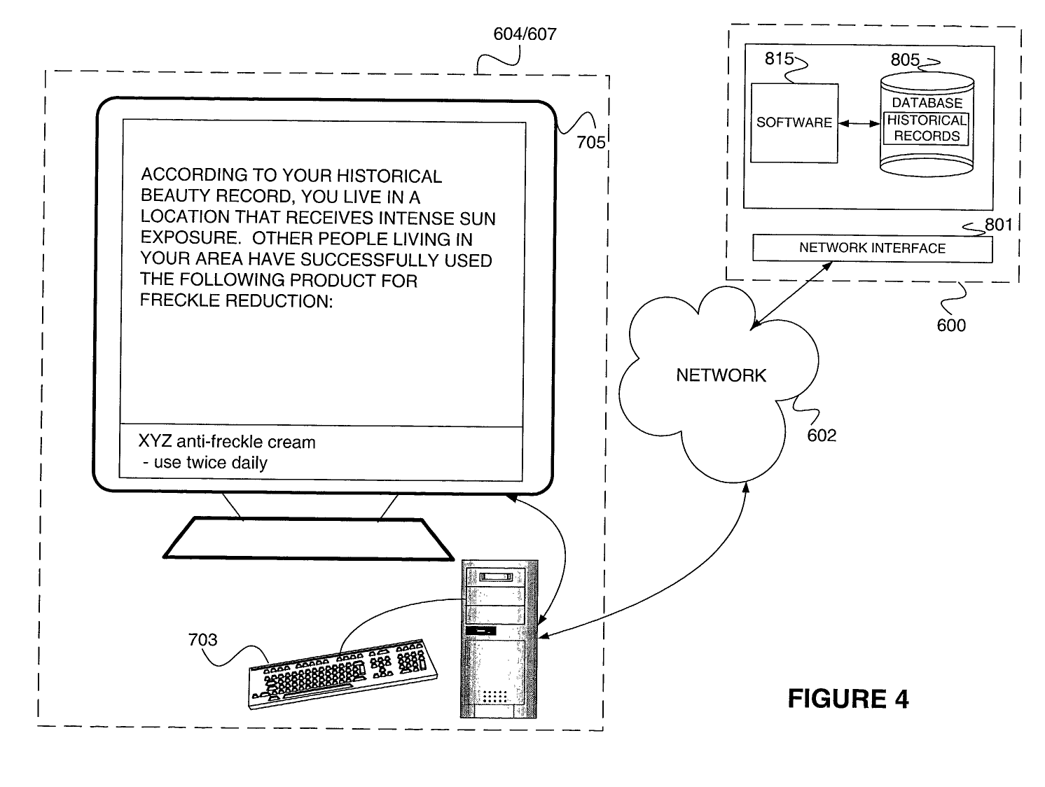

In yet another embodiment, product recommendations and advice may be based on a subject's pre-recorded beauty information and personal information. An example of such an embodiment is illustrated in FIG. 4. Accordingly, the present invention may include software containing one or more of a comparison mechanism. In one embodiment, the comparison mechanism may determine whether a subject's beauty product usage is consistent with the beauty product usage of individuals with similar lifestyles. In the event an inconsistency is determined, a product recommendation may be generated. For example, if a subject lives in an area of intense sunlight, the comparison mechanism may search a database containing survey or population based data derived from other individuals living in areas of intense sunlight, and make a product recommendation based thereon. Alternatively, the beauty product usage information entered by individuals living in this type of climate may be examined to determine the most appropriate product for the subject, based on the subject's personal traits and the effectiveness of products on persons with similar personal traits.

As indicated in step 215 of FIG. 2B, methods of the present invention may include facilitating the capture of an image of the subject's external condition after the subject has used a beauty product. As with step 210, “facilitating” in step 215 may occur directly or indirectly in manners previously described. Indeed, all aspects of this step may be accomplished by methods similar to those discussed previously in connection with step 210. Moreover, as with step 210, step 215 may similarly involve storing the image as discussed above. It should be understood that a subject is not limited to capturing images before and after a specific regiment of a product. Subjects may be able to capture any number images intermittently at varying intervals of time.

In one form or another, methods of the present invention, may present to the subject information reflecting usage of beauty products, as indicated in step 220 of FIG. 2B. In one embodiment, this may include enabling the subject to view, on a display device, the before and after images and the stored information, thereby permitting the subject to visually observe changes that occurred between times when the images were captured. These tools may include one or more of software, instructions, or simply access to a website, network, or hardware. Enabling may also include providing the subject with hardware such as a web cam. In its broadest sense, the invention is not limited to the form of the display sequence. For example, the first and second images may be displayed sequentially, simultaneously, or may be morphed from one to the other. Similarly, the information may be displayed together with or separate from one or more of the images.

The information displayed may include, but is not limited to, numerical, graphical, or other depictions of data, which quantify the effectiveness of beauty products. For example, the subject may be presented with charts, graphs, diagrams, and other graphical representations of data. Alternatively and/or in addition, the displayed information may include an indication of a product used during the time between capture of the before and after images. This usage indication may include text and/or a depiction of the product or products used. This information may further include details of the treatment regiment followed, and/or unique environmental or personal information relating to the time period. For example, the information may include an indication that the subject took a tropical vacation, receiving high levels of sun exposure, during the time lapse.

In one embodiment, the differences between the before and after images may be visually accentuated, thereby enhancing the subject's appreciation of the product's effectiveness or lack thereof. Accentuating may involve extracting the differences between the images and presenting the extracted portions to the user. This may further involve visually enhancing, zooming, or isolating the external condition. Accentuating may be accomplished by using one or more image processing mechanisms, either directly or with the aid of a third party. For example, the processing may occur after transmission of the images over a network to an intervening server that uses highly specialized processes and routines for image manipulation and enhancement.

Referring back to FIG. 1, there is shown by way of example, a screen shot depicting the presentation of information reflective of beauty product usage and effectiveness. As illustrated, images of the external condition before and after product use may be simultaneously displayed. As depicted, a graph and chart may also be presented. In one embodiment, various visual markers may also be presented such as points “A”, “B”, and “C” in FIG. 1. These markers may represent specific points in time and may be linked to corresponding images and information. Accordingly, when a subject selects a marker, the corresponding image and information may be presented. Take for instance a subject that initially captures and stores an image of freckles (subsequently referred to as the reference image). The subject uses a freckle reducing agent for six months, capturing and storing images at various points within that time. The subject may be able to select a marker, for example “A”, which would display the reference image and the image taken on the date associated with point “A”. In addition to the images, product usage and personal information may also be displayed. Such information may include the dosage and frequency at which the product was being applied. If the subject then selects another marker, for example point “B”, the reference image and an image taken on the date associated with point “B” may be displayed.

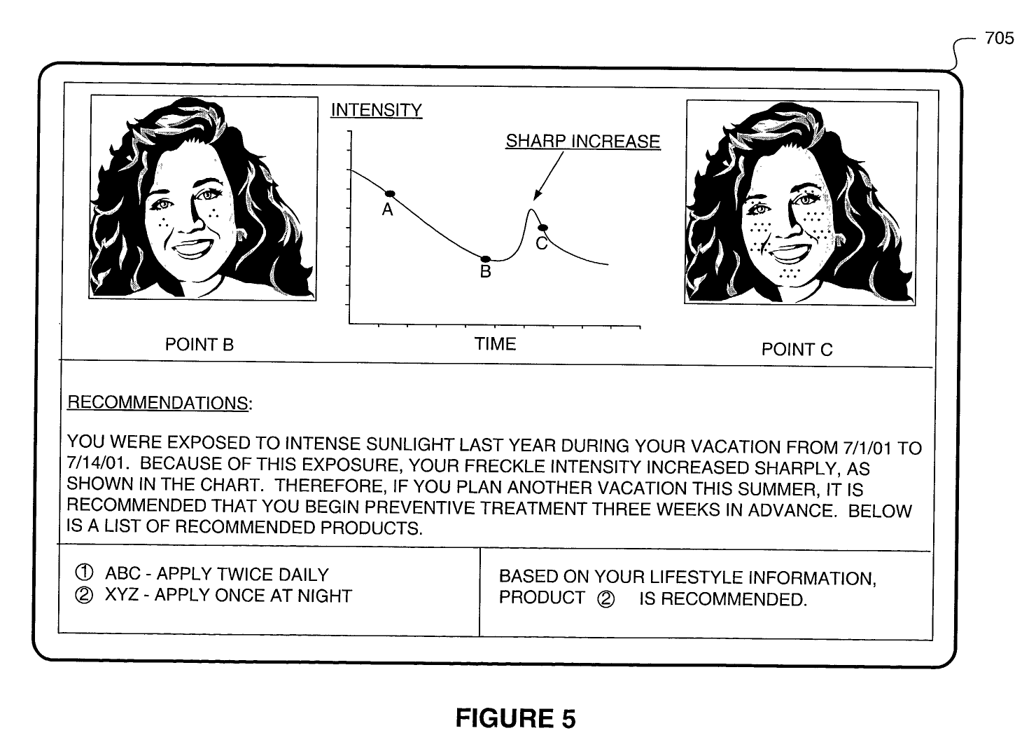

In alternative embodiments of the present invention, advice may be provided to subjects based on a plurality of captured images. For example, product recommendations may be presented to a subject as a result of detected differences between images. One example of such an implementation is illustrated in FIG. 5. As discussed above, intermediate points may be presented and selected by the subject. However, a subject may also be able to view intermediary periods, for example, by selecting a portion of the curve located between points “A” and “B”. Accordingly, images associated with “A” and “B” may be displayed. However, in this case, differences between the images may be detected via the image processing mechanism. These detected differences, along with the subject's personal and beauty information, may be used for providing advice. For instance, if an external condition worsens over a particular period of time, the subject's personal information may be searched to determine a cause. Upon detecting a difference and determining a probable cause, the resulting information may be displayed to the subject along with preventative or remedial measures. In the example of FIG. 5, freckles are recorded as increasing sharply between points “B” and “C”. FIG. 5 also illustrates a message indicating the possible cause and a preventative measure to avoid future setbacks. As illustrated, a list of effective beauty products may also be displayed along with a recommendation based on the subject's personal information.

Beauty care methods consistent with exemplary embodiments of the present invention may be practiced in system 60 of FIG. 6. As illustrated, system 60 may include product distributor 600, beauty facility 604, and remote location 607, coupled to network 602. Remote location 607 may include a home, office, or any other location remotely located with respect to beauty facility 604. As illustrated, distributor 600 may contain distributor server 601 coupled, via network 602, to facility access system 605 and remote access system 608.

For the sake of brevity, FIG. 6 shows a single beauty facility coupled to network 602. However, one skilled in the art will appreciate that system 60 may comprise any number of geographically dispersed beauty facilities each having access systems coupled to network 602. Similarly, system 60 may comprise any number of geographically dispersed remote locations each having access systems coupled to network 602.

Network 602 may be a public network such as the Internet, a virtual private network, or any other mechanism for enabling communication between two or more nodes or locations. The network may include one or more wired and/or wireless connections. Distributor server 601, facility access system 605, and remote access system 608 may, in an exemplary embodiment, be operatively connected to network 602 by communication devices and software known in the art, such as are commonly employed by Internet service providers or as part of an Internet gateway.

In one embodiment, a subject may be able to capture an image at beauty facility 604. Accordingly, image capture device 715 of FIG. 7 may be provided to facilitate the image capture. Image capture device 715 may include a digital camera, digital video camera, scanner, web cam, or any other device capable of electronically capturing body images.

As illustrated in FIG. 7, image capture device 715 may reside in beauty facility 604 and may be operatively connected to facility access system 605. Facility access system 605 may be a desktop computer, terminal, or any other device capable of facilitating the use of image capture device 715 and communicating with network 602. Facility access system 605 may include network interface 701, user interface 703, display device 705, processor 707, memory 709, and data port 711. Image capture device 715 may be coupled to access system 605 via data port 711 and may communicate with access system 605 using device driver 712 located in memory 709. As used herein, “memory” refers to any device capable of storing information including, but not limited to, RAM, ROM, magnetic and optical storage, organic storage, audio disks, and video disks. Display device 705 may be configured to output the images captured by image capture device 715, as well as text and other information, by way of a cathode ray tube, liquid crystal, light-emitting diode, gas plasma, or any other type of display mechanism.

User interface 703 may be an input port connected by a wired, optical, or a wireless connection for electromagnetic transmissions. User interface 703 may include at least one button actuated by the user to input commands to select from a plurality of processor operating modes. User interface 703 may also include a keyboard, a mouse, and/or a touch screen. In alternative embodiments, user interface 703 may include connections to other computer systems to receive the input commands and data therefrom. Moreover, user interface 703 may further include a data reading device for reading information from, and writing information to, computer readable medium including, but not limited to, magnetic and optical disks. Such data reading devices may include, for example, a disk drive for reading and writing to a floppy or optical disk.

Processor 707 may be operatively configured to execute instructions received via memory 709, user interface 703, data port 711, and network interface 701. Facility access system 605 may be connected to network 602 via network interface 701, which may be operatively connected via a wired and wireless communications link. Network interface 701 may be a network interface card, unit, or any other type of dedicated network connection. In operation, network interface 701 may be used to send data to and receive data from network 602.

As previously mentioned, a subject may be encouraged to capture images at a location remotely located with respect to the beauty facility. Accordingly, image capture device 715 may reside in remote access system 608 of remote location 607. In one embodiment, remote access system 608 may be a personal computer and may comprise components similar to those described in connection with access system 605.

As explained above, one or more mechanisms may be provided for capturing, maintaining, and analyzing images, as well as comparing information, and providing advice. In one embodiment, these mechanisms may be software-based and may include neural networks, decision trees, artificial intelligence engines, or any other logic-based apparatus or processes.

For clarity of explanation, the functionality of each mechanism, described herein, is distinguished. However, it is to be understood that, in operation, the functionality of these mechanisms may differ from what is described. For example, the mechanisms may be separate, each residing at different locations, or they may be integrated into one software package residing at a common location. For example, software 815 may be separated into sub-packages, each located at any given component within system 60. Thus, the mechanism for operating the image capture device may be in the form of a device driver located in memory 709 of facility access system 605, while the image processing and comparison mechanisms may reside in software 815 located in memory 809 of server system 601 (FIG. 8).

In one embodiment, facility access system 605 and/or remote access system 608 may access software 815 on via network 602. However, as mentioned above, software 815 could reside in other locations. For example, a CD-ROM or floppy disk containing software 815 could be provided to beauty facility 604 from distributor 600 and uploaded onto facility access system 605. In another embodiment, facility access system may download the software from server 601 via network 602. In other embodiments, distributor 600 may supply beauty facility with a plurality of computer readable media containing the software for distribution. For example, subjects could obtain the necessary software at a beauty salon and upload the software on their home computers. Subjects could also download the software from distributor server 601 or facility access system 605 via network 602. In yet another embodiment, the software may be distributed and shared among distributor server 601, facility access system 605, and remote access system 608.

As shown in FIG. 8, distributor server 601 may comprise components similar to those described in connection with terminal 605 including network interface 801 and processor (CPU) 807. Further, database 805 may be coupled to distributor server 601 for maintaining data on a plurality of subjects. Database 805 may include a relational database, distributed database, object-oriented programming database, or any other aggregation of data that can be accessed, managed, and updated. While database 805 is illustrated with a single icon, it is to be understood, as with all other components described herein, that its functionality may be distributed amongst several discrete components.

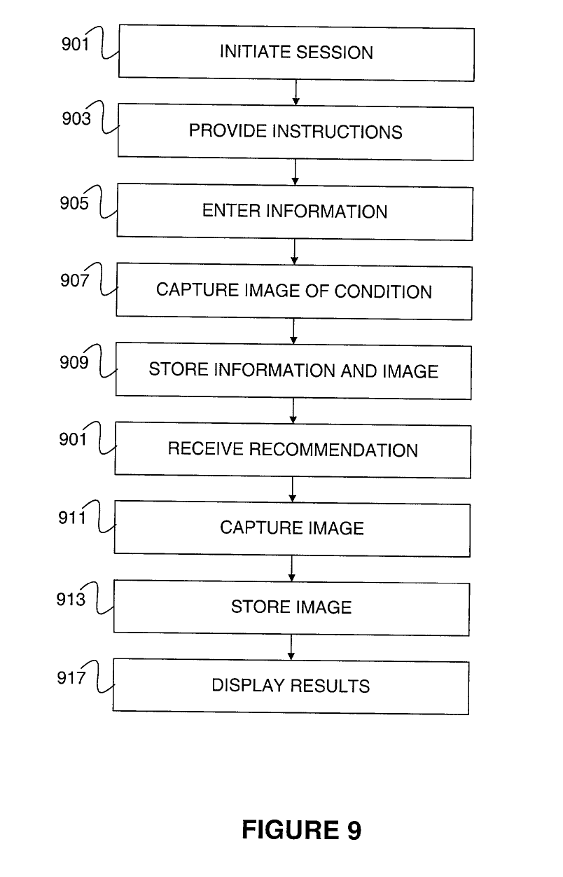

In operation, an exemplary embodiment of the present invention may function in accordance with the steps illustrated in the flowchart of FIG. 9. However, it should be understood that other methods may be used to implement the invention, and even with the method disclosed in FIG. 9, the particular order of events may vary without departing from the scope of the present invention. Further, certain steps may not be present and additional steps may be added without departing from the scope and spirit of the claimed invention.

As indicated in step 901, a session may be established. In this exemplary embodiment, step 901 may involve a subject logging on to facility access system 605 and communicating with server system 601, using network 602, via access system 605. This step may also involve issuing a password to the consumer for identification in later sessions. Upon establishing a session, software 815 may present instructions to the subject via display device 705, as indicated in step 903. In one embodiment, these instructions may include detailed steps about operating image capture device 715, and entering and storing personal and beauty information.

A subject may then enter personal and/or beauty information into access system 605, using user interface 703. This is depicted in step 905. In one example, a subject may enter information via a keyboard. However, alternative embodiments may include audio capture devices for receiving information.

As indicated by step 907, the subject may capture an image of an external body condition using image capture device 715. This may occur, for example, using a web cam to take a picture of wrinkles on the subject's face. In one embodiment, image capture device 715 may communicate with access system 605 via the device driver.

Once the information and image is obtained from the subject, it may be stored as indicated in step 909. This step may involve storing the data in a data structure (e.g., a linked list) in memory 709 of access system 605, memory 809 of server system 601, or in database 805 coupled to either system. Step 909 may also involve storing the data on transportable media, such as floppy, optical, or zip disk.

As indicated in step 911, the subject may receive advice corresponding to the information and image. In one embodiment, this may involve software 815 analyzing the data and prescribing a beauty product, such as anti-wrinkle cream. After the subject uses the recommended product, she may capture and store another image, as indicated in steps 913 and 915. Performance of these steps may occur in a manner similar to steps 907 and 909. In other exemplary embodiments, any or all of these steps may be performed at remote location 607, or in a combination of a remote location and a beauty facility.

Upon receiving images before and after the use of a beauty product, the effects of the product may be displayed to the subject. This is illustrated by step 917. Software 815 may process the data, via processor 307, and cause the results to be presented via display device 705. As previously discussed, one example of a display is illustrated in FIG. 1. Accordingly, the subject is provided with a visual and quantified indication of her beauty care progress. It should be understood that the user may then continue to capture images and enter information, thereby creating a historical record of their beauty care. It should also be understood that processes described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

It will be apparent to those skilled in the art that various modifications and variations can be made in the systems, methods and apparatus of the present invention and in the construction of this invention without departing from the scope of or spirit of the invention.

This application may discuss beauty products in connection with use by women. However, it is to be understood that such discussions are for exemplary purposes only. It is to be understood that the invention is equally applicable to all genders, and is not necessarily limited to the beauty industry. It is also to be understood that any functional aspect of the invention can be implemented via any location in the system or network, and data software may be resident at any location either in a network, at a stand-alone site, or on media in the custody and control of a user or subject.

It is to be further understood that the physical mechanisms (e.g. hardware, software, networks, systems) for implementing the methods of the invention are many. Networks, hardware and systems can be configured in a host of ways with software and hardware functionality residing at many alternative locations. In addition, systems other than the exemplary systems disclosed might be used to implement the invention. Therefore, it is to be understood that the methods of the invention are not limited to any particular structure.

Further, methods or portions thereof can be implemented in either an electronic environment, a physical environment, or combinations thereof. Thus, for example, although one or more portions of a method may occur in an electronic environment, a “purchase” portion of the method may occur in a brick and mortar store, or vice versa.

### Cross-reference to Concurrently Filed Applications and Global Definitions

This application claims priority on and incorporates by reference the following U.S. Provisional applications: Artificial Intelligence For Use In Cosmetic And Non-Cosmetic Environments, Application No. 60/325,561 (provisional filed Oct. 1, 2001); and Methods And Systems For Cosmetic And Non-Cosmetic Product Selection, Application No. 60/325,559 (provisional filed Oct. 1, 2001).

The following concurrently filed U.S. patent applications are also incorporated herein by reference: Body Image Enhancement, Attorney Docket No. 05725.0972; Methods And Systems For Predicting And/Or Tracking Changes In External Body Conditions, Attorney Docket No. 05725.0973; Methods And Systems For Generating A Prognosis, Attorney Docket No. 05725.0974; Identification And Presentation Of Analogous Beauty Case Histories, Attorney Docket No. 05725.0976; Interactive Beauty Analysis, Attorney Docket No. 05725.0977; Feature Extraction In Beauty Analysis, Attorney Docket No. 05725.0978; Simulation Of An Aesthetic Feature On A Facial Image, Attorney Docket No. 05725.0979; Beauty Advisory System And Method, Attorney Docket No. 05725.0980; Virtual Beauty Consultant, Attorney Docket No. 05725.0981; Calibrating Image Capturing, Attorney Docket No. 05725.0982; Use Of Artificial Intelligence In Providing Beauty Advice, Attorney Docket No. 0572.0983; Shop-In-Shop Website Construction, Attorney Docket No. 05725.0984; Early Detection Of Beauty Treatment Progress, Attorney Docket No. 05725.0985; Cosmetic Affinity Indexing, Attorney Docket No. 05725.0986; Systems And Methods For Providing Beauty Guidance, Attorney Docket No. 05725.0987; Methods And Systems Involving Simulated Application Of Beauty Products, Attorney Docket No. 05725.1008; Customized Beauty Tracking Kit, Attorney Docket No. 05725.1009; Analysis Using Three-Dimensional Facial Image Attorney Docket No. 05725.1010; Body Image Templates With Pre-Applied Beauty Products, Attorney Docket No. 05725.1011; and Image Capture Method, Attorney Docket No. 05725.1012.

To the extent not inconsistent with the invention defined herein, definitions and terminology usage in the above-mentioned concurrently filed applications, the above-mentioned priority applications, and the following global definitions are to be considered in interpreting the language of this patent and the claims herein. Where multiple definitions are provided, they should be considered as a single cumulative definition.

The term “image” may include one or more of two-dimensional and three-dimensional representations. In certain examples consistent with the invention, a plurality of images from different perspectives may be used to construct a three-dimensional image. In a broader sense, only a single image may be used. Depending on the embodiment, the term “image” may include either a visually perceptible image or electronic image data that may be either used to construct a visually perceptible image or to derive information about the subject. The image may be a body image corresponding to an anatomical portion of the subject, and may represent, for example, the subject's entire face, or a portion of the subject's face. The image may be a detailed picture (e.g., a digital image or a photograph) of a portion of the subject's body and/or a topological plot mapping contours of a portion of subject's body. If the image is representative of an external body condition, the image could be either an actual image showing the condition or an image including symbolizations of the condition, for example. The image may be an actual or a simulated image. Simulated images may include wholly or partially generated computer images, images based on existing images, and images based on stored features of a subject.

The term “image capture device”, similar terms, and terms representing structures with similar functions may include one or more of a digital camera, webcam, film camera, analog camera, digital video camera, scanner, facsimile machine, copy machine, infrared imager, ultra-sound imaging device, or any other mechanism for acquiring an image of a subject's external body condition, an image of the subject's countenance, an/or an image of the subject's skin. An ultrasonic device might provide skin thickness information, or it might create a map on an area of the external location. Thus, the term “image” as used herein may be broader than a picture. Combinations of image capture devices may be used. For example, an image captured on photographic paper using a film camera might then be scanned on a flat bed scanner to create another image.

The term “capturing (an image)”, or any form thereof, refers to the use of an image capture device to acquire an image. “Capturing” may refer to the direct act of using the image capture device to acquire the image. It may also include indirect acts to promote acquisition. To this end, “capturing” may include the indirect acts of providing access to hardware, or to at least one of a client-based algorithm and a server-based algorithm for causing the image capture device to capture an image. This may be accomplished by providing a user with software to aid in the image capture process, or providing the user with access to a network location at which the software resides. Also consistent with certain embodiments of the invention, capturing may include at least one of receiving an instruction from the subject to capture an image, indicating to the subject before the image is captured, and indicating to the subject when the image is captured.

The term “image processing technique” or similar terms, may include a software program, computer, application specific integrated circuit, electronic device and/or a processor designed to identify in an image one or more characteristics, such as a skin condition. Such techniques may involve binarization, image partitioning, Fourier transforms, fast Fourier transforms (FFTs), and/or discrete cosine transforms may be performed on all or part of the image, resulting in coefficients. Based on the coefficients, conditions may be located, as known in the art. Artificial intelligence, such as fuzzy logic, neural networks, genetic programming and decision tree programming, may also be used to identify conditions. Alternatively, one or more digital filters may be passed through the image for locating specific conditions. These examples are provided for illustrative purposes with the understanding that any image processing technique may be used.

The term “network interface” or similar terms, refer to any mechanism for aiding communications between various nodes or locations in a network. A network interface may include, for example a bus, a modem, or any other input/output structure. A network interface may permit a connection to any network capable of being connected to an input and/or output module located within at least one or more of the following exemplary networks: an Ethernet network, an Internet Protocol network, a telephone network, a radio network, a cellular network, or any mechanism for permitting communication between two or more modes or remote locations. In some invention embodiments, a network interface might also included a user interface.

The term “user interface” may include at least one component such as a keyboard, key pad, mouse, track ball, telephone, scanner, microphone, touch screen, web cam, interactive voice response system (IVR), voice recognition system or any other suitable input mechanism for conveying information. A user interface may also include an input port connected by a wired, optical, or wireless connection for electromagnetic transmissions. In some embodiments, a user interface may include connections to other computer systems to receive the input commands and data therefrom. User interface may further include a data reading device such as a disk drive for receiving input data from and writing data to storage media such as magnetic and optical disks.

As used herein terms such as “external body condition”, “skin condition”, and “actual condition” refer to conditions of at least one of the skin, teeth, hair, eyebrows, eyelashes, body hair, facial hair, fingernails, and/or toenails, or any other externality. Examples of skin conditions may include elasticity, dryness, cellulitis, sweating, aging, wrinkles, melanoma, exfoliation, desquamation, homogeneity of color, creases, liver spots, clarity, lines, micro-circulation, shininess, softness, smoothness, tone, texture, matitty, hydration, sag, suppleness, stress, springiness, firmness, sebum production, cleanliness, translucency, luminosity, irritation, redness, vasocolation, vasomotion, vasodilation, vasoconstriction, pigmentation, freckles, blemishes, oiliness, pore distribution, pore size, moles, birthmarks, acne, blackheads, whiteheads, pockmarks, warts, pustules, boils, blisters, marks, smudges, specks, psoriasis and other characteristics associated with the subject's skin. Examples of hair conditions may include keratin plug, length, dryness, oiliness, dandruff, pigmentation, thickness, density, root conditions, split ends, hair loss, hair thinning, scales, staging, cleanliness and other properties related to the subject's hair. Examples of fingernail and toenail conditions may include onychomycosis, split nails, delaminating, psoriasis, brilliancy, lines, spots, coloration, gloss, strength, brittleness, thickness, hangnail, length, disease, and other characteristics related to the subject's nails. Other conditions may include, for example, size and proportion of facial features, teeth discoloration, and any other aesthetic-related or physical, physiological, or biological conditions of the user.

“Enabling”, “facilitating”, and “causing” an action refer to one or more of a direct act of performing the action, and any indirect act of encouraging or being an accessory to the action. Thus, the terms include partnering or cooperating with an entity who performs the action and/or referring commerce to or having commerce referred from an entity who performs the action. Other examples of indirect activity encompassed within the definitions of “enabling”, “facilitating”, and “causing” may include providing a subject with one or more of tools to knowingly aid in performing the action, providing instructions on how to perform the action, providing prompts or cues to perform the action, or expressly encouraging performance of the action. Indirect activity may also include cooperating with an entity who either directly performs the action or who helps another perform the action. Tools may include software, hardware, or access (either directly, through hyperlink, or some other type of cooperation or partnering) to a network location (e.g., web site) providing tools to aid in performing the action. Thus, phrases such as “enabling access” and “enabling display” do not necessary require that the actor actually access or display anything. For example, the actor may perform the enabling function by affiliating with an entity who performs the action, or by providing instructions, tools, or encouragement for another to do the accessing and displaying.

Forms of the word “displaying” and like terms may also include indirect acts such as providing content for transmission over a network to a display device, regardless of whether the display device is in the custody or control of the sender. Any entity in a chain of delivering information for display performs an act of “displaying”, as the term is used herein.

Likewise, the term “providing” includes direct and indirect activities. For example, providing access to a computer program may include at least one of providing access over a network to the computer program, and creating or distributing to the subject a computer program configured to run on the subject's workstation or computer. For example, a first party may direct network traffic to (either through electronic links or through encouragement to visit) a server or web site run by a second party. If the second party maintains a particular piece of software thereon, then it is to be understood that within the meaning of “providing access” as used herein, the first party is said to provide access to the particular software. Or if the first party directs a subject to a second party who in turn ships the particular software to the user, the first party is said to provide the user with access to the particular software. (Of course, in both of the above instances, the second party would also be providing access within the meaning of the phrase as used herein.) “Receiving” may include at least one of acquisition via a network, via verbally communication, via electronic transmission, via telephone transmission, in hard-copy form, or through any other mechanism enabling reception. In addition, “receiving” may occur either directly or indirectly. For example, receipt may occur through a third party acting on another party's behalf, as an agent of another, or in concert with another. Regardless, all such indirect and direct actions are intended to be covered by the term “receiving” as used herein. A received request, for example, may take one of many forms. It may simply be a checked box, clicked button, submitted form or oral affirmation. Or it might be a typed or handwritten textual request. Receiving may occur through an on-line interest form, e-mail, facsimile, telephone, interactive voice response system, or file transfer protocol transmitted electronically over a network at a web site, an internet protocol address, or a network account. A request may be received from a subject for whom information is sought, or an entity acting on the subject's behalf. “Receiving” may involve receipt directly or indirectly through one or more networks and/or storage mediums. Receipt may occur physically such as in hard copy form, via mail delivery or other courier delivery.

Forms of the word “maintain” are used broadly to include gathering, storing, accessing, providing access to, or making something available for access, either directly or indirectly. For example, those who maintain information include entities who provide a link to a site of a third party where the information is stored.

Consistent with the concepts set forth above, all other recited actions such as, for example, obtaining, determining, generating, selecting, applying, simulating, presenting, etc., are inclusive of direct and indirect actions. Thus, for purposes of interpreting the following claims, an entity performs a recited action through either direct or indirect activity. Further examples of indirect activity include sending signals, providing software, providing instructions, cooperating with an entity to have the entity perform the action, outsourcing direct or indirect actions, or serving in any way as an accessory to the specified action.

The term “product” is used to generically refer to tangible merchandise, goods, services, and actions performed. A “beauty product,” “beauty care product,” “cosmetic product” or similar terms, refer to products (as defined above) for effecting one or more external body conditions, such as conditions of the skin, hair and nails. Examples of tangible merchandise forms of beauty products include cosmetic goods, such as treatment products, personal cleansing products, and makeup products, in any form (e.g., ointments, creams, gels, sprays, supplement, ingesta, inhalants, lotions, cakes, liquids, and powders.)

Examples of services forms of beauty products include hair styling, hair cutting, hair coloring, hair removal, skin treatment, make-up application, and any other offering for aesthetic enhancement. Examples of other actions performed include massages, facial rubs, deep cleansings, applications of beauty product, exercise, therapy, or any other action effecting the external body condition whether performed by a professional, the subject, or an acquaintance of the subject.

The following is exemplary and non-exhaustive listing of a few beauty products- scrubs, rinses, washes, moisturizers, wrinkle removers, exfoliates, toners, cleansers, conditioners, shampoos, cuticle creams, oils, and antifungal substances, anti-aging products, anti-wrinkle products, anti-freckle products, skin conditioners, skin toners, skin coloring agents, tanners, bronzers, skin lighteners, hair coloring, hair cleansing, hair styling, elasticity enhancing products, agents, blushes, mascaras, eyeliners, lip liners, lipsticks, lip glosses, eyebrow liners, eye shadows, nail polishes, foundations, concealers, dental whitening products, cellulite reduction products, hair straighteners and curlers, and weight reduction products. A beauty care treatment regimen may involve the administration of one or more products, as defined above.

The terms “beauty advice”, “beauty guidance”, and similar terms are used interchangeably to refer to the provision of beauty related information to a subject. Advice or guidance includes one or more of beauty product recommendations (e.g., cosmetic product recommendations for products to treat conditions the subject is prompted to evaluate), remedial measures, preventative measures, predictions, prognoses, price and availability information, application and use information, suggestions for complementary products, lifestyle or dietary recommendations, or any other information intended to aid a subject in a course of future conduct, to aid a subject in understanding past occurrences, to reflect information about some future occurrences related to the subject's beauty or to aid a subject in understanding beauty products, as defined above.

The term “network” may include a public network such as the Internet or a telephony network, a private network, a virtual private network, or any other mechanism for enabling communication between two or more nodes or locations. The network may include one or more of wired and wireless connections. Wireless communications may include radio transmission via the airwaves, however, those of ordinary skill in the art will appreciate that various other communication techniques can be used to provide wireless transmission including infrared line of sight, cellular, microwave, satellite, blue-tooth packet radio and spread spectrum radio. Wireless data may include, but is not limited to, paging, text messaging, e-mail, Internet access and other specialized data applications specifically excluding or including voice transmission.

In some instances consistent with the invention, a network may include a courier network (e.g. postal service, United Parcel Service, Federal Express, etc.). Other types of networks that are to be considered within the scope of the invention include local area networks, metropolitan area networks, wide area networks, ad hoc networks, or any mechanism for facilitating communication between two nodes or remote locations.

“Artificial intelligence” (AI) is used herein to broadly describe any computationally intelligent systems that combine knowledge, techniques, and methodologies. An AI engine may be any system configured to apply knowledge and that can adapt itself and learn to do better in changing environments. Thus, the AI engine may employ any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing. Employing any computationally intelligent techniques, the AI engine may learn to adapt to unknown or changing environment for better performance. AI engines may be implemented or provided with a wide variety of components or systems, including one or more of the following: central processing units, co-processors, memories, registers, or other data processing devices and subsystems.

AI engines may be trained based on input such as product information, expert advice, user profile, or data based on sensory perceptions. Using input an AI engine may implement an iterative training process. Training may be based on a wide variety of learning rules or training algorithms. For example, the learning rules may include one or more of the following: back-propagation, real-time recurrent learning, pattern-by-pattern learning, supervised learning, interpolation, weighted sum, reinforced learning, temporal difference learning, unsupervised learning, or recording learning. As a result of the training, AI engine may learn to modify its behavior in response to its environment, and obtain knowledge. Knowledge may represent any information upon which AI engine may determine an appropriate response to new data or situations. Knowledge may represent, for example, relationship information between two or more products. Knowledge may be stored in any form at any convenient location, such as a database.

Since AI engine may learn to modify its behavior, information describing relationships for a universe of all combinations of products may not need to be maintained by the AI engine or any other component of the system.

“Personal information”, “subject specific information”, “user specific information”, “user profile”, “personal characteristics”, “personal attributes”, “profile information”, and like terms (collectively referred to in this section as “personal information”) may broadly encompass any information about the subject or user. Such information may, for example, fall within categories such as physical characteristics, fashion preferences, demographics, nutritional information, cosmetic usage information, medical history information, environmental information, beauty product usage information, lifestyle, and may include information such as name; age; birth date; height; weight; ethnicity; eating habits; vacation patterns; geographic location of the individual's residence, location, or work; work habits; sleep habits; toiletries used; exercise habits; relaxation habits; beauty care habits; smoking and drinking habits; sun exposure habits; use of sunscreen; propensity to tan; number of sunburns and serious sunburns; dietary restrictions; dietary supplements or vitamins used; diagnosed conditions affecting the external body, such as melanoma; an image, such as a picture or a multimedia file of the subject; facial feature characteristics; family history information such as physical characteristics information about relatives of the subject (e.g., premature balding, graying, wrinkles, etc.); external body condition (as defined previously); color preferences, clothing style preferences, travel habits; entertainment preferences; fitness information; adverse reactions to products, compounds, or elements (e.g., sun exposure); body chemistry, use of prior beauty care products and their effectiveness; purchasing, shopping, and browsing habits; hobbies; marital status; whether the subject is a parent; country of residence; region of residence; birth country and region; religious affiliation; political affiliation; whether the subject is an urban dweller suburban dweller or rural area dweller; size of urban area in which the subject lives; whether the subject is retired; annual income, sexual preference, or any other information reflecting habits, preferences, or affiliations of the subject.

Personal information may also include information electronically gleaned by tracking the subject's electronic browsing or purchasing habits, or as the result of cookies maintained on the subject's computer, responses to surveys, or any other mechanism providing information related to the subject. In addition, personal information may be gathered through non-electronic mechanisms such as hard copy surveys, personal interviews, or consumer preference polls.

“Complementary” and “complementary product” refers to one or more of physical, physiological, biologically, and aesthetic compatibility. A product may be complementary with one or more of another product, a group of products, or a subject. In that latter instance, whether a product is considered “complementary” may be a function of personal information of the subject. Thus, for example a product may be complementary if it is unlikely to cause an adverse allergic reaction; if it physically blends well with another product; or if it is aesthetically consistent with the subject or one or more other products. Aesthetic compatibly may refer to the fact that two products are aesthetically appealing (or do not clash) when worn together. The identification of a complementary product may also be based on product characteristics, user preferences, survey data, or expert advice.

As used herein, the words “may” and “may be” are to be interpreted in an open-ended, non-restrictive manner. At minimum, “may” and “may be” are to be interpreted as definitively including structure or acts recited. Further, the word “or” is to be interpreted in the conjunctive and the disjunctive.

While flow charts presented herein illustrate a series of sequential blocks for exemplary purposes, the order of blocks is not critical to the invention in its broadest sense. Further, blocks may be omitted and others added without departing from the spirit of the invention. Also, the invention may include combinations of features described in connection with differing embodiments.

Although a focus of the disclosure may be on server-side methods, it is nevertheless to be understood that the invention includes corresponding client-side methods, software, articles of manufacture, and computer readable media, and that computer readable media can be used to store instructions for some or all of the methods described herein. Further, it is to be understood that disclosed structures define means for implementing the functionality described herein, and that the invention includes such means for performing the disclosed functions.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Exemplary Embodiments, with each claim standing on its own as a separate embodiment of the invention.

What is claimed is:

1. A beauty care method, comprising:
obtaining first information representative of an external body condition of a subject;
obtaining second information representative of the external body condition of the subject after the subject uses a beauty product;
facilitating storage of information reflecting the subject's usage of the beauty product; and
enabling the subject to view the first information, the second information, and at least part of the stored information.

2. The method of claim 1, wherein at least one of the first information and the second information is an image of the external body condition.

3. The method of claim 1, wherein each of the first information and the second information includes an image of the external body condition.

4. The method of claim 1, conducted in a network environment, wherein obtaining the first information and obtaining the second information occurs over a network and at a location remote from the subject.

5. A beauty care method, comprising:
providing information about beauty products;
facilitating electronic capture of a first image of an external body condition of a subject;
encouraging the subject to use at least one of the beauty products;
facilitating, after the subject has used the at least one beauty product, electronic capture of a second image of the external body condition of the subject, wherein capture of at least one of the first and second images occurs at a beauty facility;
facilitating capture and storage of information reflecting usage of at least one of the beauty products by the subject, the usage occurring on at least one occasion between capture of the first image and capture of the second image; and
enabling the subject to view the first image, the second image, and the stored information on a display device, to thereby visually observe changes that occurred between times when the first and second images were captured.

6. The method of claim 5, wherein providing information about beauty products includes at least one of offering beauty products for sale directly to consumers, offering beauty products for sale to consumers via a retail sales establishment, and offering beauty products through beauty facilities.

7. The method of claim 5, wherein the beauty facility is at least one of a hair salon, a spa, or another establishment providing beauty services.

8. The method of claim 5, wherein the beauty products include at least one of moisturizer, anti-aging product, anti-wrinkle product, hair coloring, elasticity enhancing product, and cosmetic products.

9. The method of claim 5, wherein the at least one beauty products includes at least one service including hair styling, hair cutting, hair coloring, hair removal, skin treatment and make-up application.

10. The method of claim 5, wherein enabling electronic capture of at least one of the first and second first images includes providing the beauty facility with least one of software, an image capture device and directions for capturing images.

11. The method of claim 5, wherein enabling electronic capture of at least one of the first and second first images includes providing access, via a network, to image capture and management software.

12. The method of claim 5, wherein the external body condition is a skin condition of the subject's face.

13. The method of claim 5, wherein encouraging the subject to use at least one of the beauty products includes providing to the beauty facility directions for prescribing at least one of the beauty products.

14. The method of claim 13, wherein the directions are contained within software and wherein the software is configured to cause a prescription to be displayed to the subject on the display in the beauty facility.

15. The method of claim 5, further comprising enabling simultaneous display to the subject of the first and second images, and enabling the subject to identify differences between the first and second images.

16. The method of claim 5, wherein encouraging the subject to use at least one of the beauty products includes prescribing at least one beauty product to the subject as a function of detected differences between the first and second images.

17. The method of claim 12, wherein the differences are electronically ascertained using an image processing comparison between the first and second images.

18. The method of claim 12, wherein the subject is encouraged to auto-evaluate the first and second images to thereby detect differences.

19. The method of claim 5, wherein enabling electronic image capture includes providing a driver for an electronic image capture device.

20. The method of claim 15, wherein the electronic image capture device is at least one of a digital still camera, a digital video camera, a scanner, and a web cam.

21. The method of claim 5, implemented through cooperation between a beauty product distributor and at least one beauty facility, wherein the distributor encourages consumers to visit the at least one beauty facility, and enables the beauty facility to access software for capturing and recording at the beauty facility at least one of the first and second images.

22. The method of claim 5, implemented through cooperation between a beauty product distributor and at least one beauty facility, wherein the distributor enables the beauty facility to access software for capturing and recording at the beauty facility at least one of the first and second images, and wherein the distributor provides to the beauty facility at least one of the beauty products.

23. The method of claims 21 or 22, wherein the distributor is at least one of a manufacturer, reseller, and wholesaler of at least one of the beauty products.

24. The method of claim 23, wherein the distributor also provides to the beauty facility recordable media, chosen from at least one of magnetic storage media, optical disc media, flash memory devices, or other tangible media upon which computer readable information may be recorded, the recordable media for use in storing the first and second images and the information about use.

25. The method of claim 24, wherein the recordable media includes a visible marking identifying at least the distributor.

26. The method of claim 24 or 25, wherein the recordable media includes marking identifying the beauty facility.

27. The method of claim 5, further comprising enabling the subject to view the first and second images at locations remote from the beauty facility.

28. The method of claim 5, further comprising enabling the beauty facility to store the first image on recordable media, and encouraging the beauty facility to recommend to the subject that the subject capture and store the second image on the recordable media at a location remote from the beauty facility.

29. The method of claim 5, further comprising enabling the beauty facility to store the first image on recordable media, and encouraging the beauty facility to recommend to the subject that the subject return to the beauty facility for capture and storage of the second image on the recordable media.

30. The method of claim 5, conducted in a network environment, wherein at least some processing functions occur at a location remote from the beauty facility.

31. A method of recording beauty information, the method comprising:
capturing, through a beauty facility, at least a first image of an external condition of a subject;
establishing a subject record, the record including the first image;
prescribing a cosmetic product to the subject for treating the external condition;
capturing, through the beauty facility, at least a second image of the external condition of the subject, the second image being captured after the first image is captured;
associating the at least one second image with the subject record; and
providing the subject with viewing access to the subject record.

32. A method of selling cosmetic products, the method comprising:
providing a beauty facility with technology for capturing external body condition images of a customer;
distributing at least one cosmetic product to the beauty facility;
instructing the beauty facility to capture images of the external body condition before and after application of the at least one cosmetic product;
instructing to beauty facility to display to the customer the before and after images so that the customer may be provided with a visual indication of progress.

33. The method of claim 32, wherein instructing the beauty facility to capture images includes instructing the beauty facility on how to record images on a transportable medium.

34. The method of claim 32 or 33, further comprising providing the customer with software that enables the customer to view the images at a location remote from the beauty facility.

35. The method of claim 34, wherein providing the customer with software, includes providing the customer with access to a web site through which the images are viewable.

36. The method of claim 34, wherein providing the customer with software includes distributing the software to the customer through the beauty facility.

37. The method of claim 32, further comprising enabling the customer to capture images to the transportable medium at a location remote from the beauty facility.

38. The method of claim 37, further comprising enabling the customer to associate with each image a record of a beauty product used before each image is recorded.

39. A beauty analysis method, comprising:
enabling a subject to record personal beauty information on a transportable medium;
enabling a plurality of beauty facilities to read the information on the transportable medium, and to update the information when the subject visits one or more of the plurality of beauty facilities; and
enabling the personal information to be updated by the subject a location remote from a beauty facility.

40. The method of claim 39, wherein the remote update is enabled, at least in part, by information exchanges initiated by the subject over an electronic network.

41. The method of claim 39, wherein the personal beauty information includes images of portions of the subjects' body.

42. The method of claim 39, wherein the transportable medium includes at least one of magnetic storage medium, optical disc, flash memory devices, or other tangible media upon which information may be recorded.

43. The method of claim 39, wherein the personal information stored on the transportable medium include time lapse images of portions of the subject's body, and wherein the subject is enabled to auto-evaluate visible changes over time, and to record the auto-evaluated visible changes on the transportable media.

44. A beauty analysis method, comprising:
enabling a beauty facility to record on transportable medium personal beauty information about a subject;
enabling the subject to access, at a location remote from the beauty facility, the personal beauty information;
enabling the subject to update, at a location remote from the beauty facility, the personal beauty information; and
enabling the subject to compare, at a location remote from the beauty facility, the accessed personal beauty information and the updated personal beauty information.

45. A beauty tracking method, comprising:
enabling an individual to record in a data structure information about the individual's cosmetic product usage;
enabling the individual to record in the data structure personal information, other than the cosmetic product usage information, the personal information including at least one of lifestyle information, information about physical characteristics of the individual, fashion preferences, area of residence, vacation patterns, and climate and weather conditions at areas of vacation and residence;
enabling an individual to update in the data structure cosmetic product usage information and personal information;
enabling the data structure to maintain a historical record of at least some of the recorded cosmetic product usage information and personal information; and
causing at least one product to be recommended to the individual, wherein the at least one product recommendation is generated using at least a portion of the historical record.

46. A beauty advisory method, comprising:
enabling a subject to record in a data structure information about the subject's cosmetic product usage and about the subject's lifestyle;
comparing the recorded information with a database of information on cosmetic usage and lifestyles of a plurality of individuals;
determining whether the subject's cosmetic usage is consistent with the cosmetic usage and lifestyles of a trend of use by at least some of the plurality of individuals; and
causing, when the subject's cosmetic usage is inconsistent with the cosmetic usage of individual's with lifestyles similar to the subject's lifestyle, at least one product to be recommended to the subject.

47. The method of claim 46, further comprising enabling the subject to record personal information about the subject's physical characteristics, and wherein the caused at least one product recommendation is a function of the subject's lifestyle and physical information.

48. A beauty tracking method, comprising:
offering for sale beauty products;
facilitating electronic capture of a first image of an external body condition of a subject;
encouraging the subject to use at least one of the beauty products;
facilitating, after the subject has used the at least one cosmetic product, electronic capture of a second image of the external body condition of the subject, wherein capture of at least one of the first and second images occurs at a beauty facility;
facilitating capture and storage of information reflecting usage of at least one of the cosmetic products by the subject, the usage occurring on at least one occasion between capture of the first image and capture of the second image; and
enabling the subject to view the first image, the second image, and the stored information on a display device, to thereby visually observe changes that occurred between times when the first and second images were captured.

49. A method for encouraging use of a beauty product, the method comprising:
providing information about beauty products;
providing instructions for storage of first information relating to an external body condition of a subject in a first time frame;
providing instructions for storage of second information relating to an external body condition of a subject in a second time frame;
analyzing the first and second information to determine an extend of differences that occurred in the body condition between the first and second time frames; and
prescribing at least one beauty product based on the extent of determined differences.

50. A method of recording beauty information, the method comprising:
providing information about beauty care;
providing instructions for storage of first information relating to an external body condition of a subject in a first time frame;
providing instructions for storage of second information relating to an external body condition of a subject in a second time frame;
providing instructions for storage of third information relating to behavior of a subject between the first and second time frames; and
establishing a subject record, the record including the first, second and third information, wherein the subject is enabled to maintain control of the subject record.

51. The method of claim 50, wherein the subject is enabled to maintain control through the use of software that stores the record at a location with access controlled by the subject.

52. The method of claim 51, wherein the location is a portable information storage medium.
